(19) United States
(12) Patent Application Publication
(10) Pub. No.: US 2024/0302401 A1
(43) Pub. Date: Sep. 12, 2024

(54) METERING HEAD AND METERING SYSTEM FOR RECEIVING AND METERING AT LEAST TWO MEDIA

(71) Applicant: FRAUNHOFER-GESELLSCHAFT ZUR FÖRDERUNG DER ANGEWANDTEN FORSCHUNG E.V., München (DE)

(72) Inventors: Christian FREESE, Mainz (DE); Peter SPANG, Mainz (DE)

(21) Appl. No.: 18/559,150

(22) PCT Filed: May 4, 2022
(86) PCT No.: PCT/EP2022/061977

§ 371 Date: May 31, 2024

(30) Foreign Application Priority Data
May 6, 2021 (DE) 102021204572.3

(51) Int. Cl. G01N 35/10; B01L 3/02

(52) U.S. Cl. CPC G01N 35/1065; B01L 3/0282; B01L 3/0289; G01N 35/1016; B01L 2200/0605; G01N 2035/1053; G01N 2035/1058

(57) ABSTRACT

A metering head for receiving and metering at least two media, having at least two media inlets, one or multiple dispensing terminals, and fluid lines connecting the media inlets to the one or multiple dispensing terminals. The one or multiple dispensing terminals each have at least two fluidically separated media outlets. A metering system, having a metering head, at least one connecting element for fluidically connecting the metering head to a carrier substrate or to a microfluidic cartridge, and optionally a connection piece, wherein the dispensing terminal is designed to receive the connecting element directly or to receive the connecting element indirectly via the connection piece.

### FIELD OF THE INVENTION

The invention relates to a metering head for receiving and metering at least two media, in particular for microfluidic applications, with at least two media inlets, one or multiple dispensing terminals and fluid lines connecting the media inlets to the one or multiple dispensing terminals.

### BACKGROUND OF THE INVENTION

The invention can be classified both in the field of pipetting heads and in the field of fluidic lab-on-a-chip systems. Prior art in these fields can be found, for example, in the documents U.S. Pat. No. 10,420,901 B2, U.S. Pat. No. 6,286,566 B1, US 2002/0056721 A1, US 2002/0172631 A1, DE 10 2020 201 143 A1, US 2010/0187452 A1, DE 10 2010 047 384 A1 or DE 10 2008 001 312 A1.

Pipettes and multichannel pipettes that work according to the reciprocating piston mechanism are known. Associated problems are that the use of such pipettes is limited to given volumes, requiring the use of different pipette types for different volumes, which in turn accommodate different sizes of pipette tips. In other words, a single multichannel pipette or a single multichannel pipette head is not sufficient to precisely pipette liquids with different volumes. This renders the use of these pipette types, especially multichannel pipettes, in automated pipetting systems complex. Moreover, these reciprocating pipettes are fixed at a certain pressure level, which means that the pressure cannot be varied.

Metering heads of the above-mentioned type solve these problems. By way of example, reference is made to the disclosure DE 10 2020 201 143 A1. It describes a metering device with a metering channel system extending between a fluid feed opening and a plurality of fluid discharge openings. The fluid to be metered is fed in via the fluid feed opening and can be discharged again in a metered manner via the fluid discharge openings. In principle, it was also recognized as possible to equip the metering channel system with multiple fluid feed openings in order to enable simultaneous multiple feeds of the fluid to be metered or different fluids that can be mixed within the metering channel system. This allows the metered dispensing of a fluid into carrier substrates, for example into so-called microtiter plates, in a partially automated and efficient manner.

Neither the known metering heads nor the pipettes and multichannel pipettes described above allow, for example, the handling of different liquids or the draining of different liquids in individual channels at different times. The known metering systems or pipette systems are therefore only suitable for universal use to a limited extent.

Unlike the dispensing of fluids in microtiter plates, the fluidics in the control of microfluidic lab-on-a-chip systems is predominantly operated via at least one syringe pump or the like installed in an operator device. Fluidic interfaces for connecting a microfluidic chip, also subsumed under the more general term “analysis cartridge”, are usually permanently installed in the operator device. For example, positioning pins and a mechanism for positioning the chip and sealing the interface are required to ensure a reliable connection between the operator device and the microfluidic cartridge. Many chip systems have a complex infrastructure for distributing samples or reagents, as well as mixing structures and other functional structural units (e.g. valves). As a result, the fluidic interfaces and the chip structure are complex. Process sequences for elaborate protocols are complex and error-prone, and in some cases cannot be implemented, especially if large sample volumes are used, which are subsequently processed into small analyte volumes in the system. Production is time-consuming and costly. Automated loading of the chip system with reagents is particularly difficult. In addition, the operator devices and chip systems are rigid when used, as they are designed for fixed, i.e. recurring processes. As such, flexibility is lacking.

The reciprocating pipettes described are not suitable to be used as actuators in automated systems. Especially when using and controlling microfluidic systems, a combination of pump, valve and possibly other components are always required alongside the pipetting unit. This makes it complex to implement complete systems. Moreover, the transfer of liquids/analytes is carried out manually to enable analysis on microfluidic cartridges. The supply without air bubbles is achieved by a chip-internal media reservoir (collecting funnel) and the subsequent transfer in the chip system via pressure and valve control and/or by means of capillary forces. It is also possible to draw the volumes into a syringe and then inject and move them in the chip system. The pre-storage of liquid reagents, washing solutions, beads, particles, antibodies and other assay-relevant liquids is implemented on the chip using so-called blisters or the like, which makes the chip system extremely costly to manufacture. To avoid this problem, the required liquids are stored upstream in the operating device. Actuation by individual liquid circuits, which have to be controlled by respective pumps, increases the manufacturing costs and the manufacturing effort.

### SUMMARY OF THE INVENTION

These and numerous other problems are solved by the invention, enabling it to be used in a considerably wider range of applications. Accordingly, the task is to provide a highly automatable metering head for a wide range of applications.

According to one aspect of the invention, the task is solved by a metering head of the type initially mentioned, which is further developed in that the one or multiple dispensing terminals each have at least two fluidically separate media outlets.

This lays the foundation for universal use of the metering head and, in particular, for transferring functionalities for recurring processes in microfluidic lab-on-chip systems from the microfluidic cartridge to the metering head or the interface. Because the one or multiple dispensing terminals each have at least two media outlets, different terminals can, for example, dispense different media at the same time and/or sequentially dispense different media. The different media can be reagents or also transport media such as air or rinsing media. From a functional point of view, one of the media can therefore be used as an actuator and the other(s) can be consumption media. Irrespective of the media function and the aggregate state, the terms metering, distributing, moving, transporting or even conveying are used here to standardize the conveying of the media through the fluidic structure.

Preparatory work outside the microfluidic cartridge can be carried out in the metering head according to the invention in units between 1-10,000 μL. The same metering head can then be used to process volumes on the microfluidic cartridge in much smaller volumes of typically 10-500 μL. The volumes to be moved per process step are therefore preferably in the range of less than 10 ml, preferably less than or equal to 1 ml and greater than or equal to 1 μL when operating a microfluidic cartridge. In the metering head according to the invention, the smallest structure sizes of the fluid structure transverse to the direction of flow are smaller than 5 mm, preferably smaller than 2 mm, particularly preferably smaller than 1 mm.

Media inlets, media outlets and fluid lines are in contact with the media and are summarized here alongside other media-carrying elements under the term fluidic structure. The functional unit around the media outlets is referred to as the dispensing terminals. A connecting element, for example in the form of a pipette tip, is assigned to each dispensing terminal, via which the media is dispensed from the metering head into a connected carrier substrate or a microfluidic cartridge. Accordingly, the dispensing terminals are configured to directly accommodate a connecting element, preferably in a liquid-tight manner, or to indirectly accommodate a connecting element via a connecting piece (adapter).

The metering head has a substrate, for instance made of a polymer material, metal, non-ferrous metal, silicon, glass or ceramic, in which the fluidic structures in general and the fluid lines in particular are formed as channels and to which the dispensing terminals are preferably moulded in one piece. For example, the metering head can be manufactured using embossing, injection moulding or deep-drawing technology or using additive manufacturing processes (3D printing). Alternatively, the fluidic structures can also be drilled or worked into the substrate material using an erosion process.

Preferably, at least one of the two media inlets can be connected to one of the at least two media outlets of one or multiple Dispensing terminals by means of a fluidically isolated fluid line. Fluidically isolated here means a direct line that connects the at least one media inlet exclusively to the one media outlet(s). For example, the isolated fluid line can be used exclusively to supply a transport medium or a rinsing medium or a reagent medium without mixing with or contamination by other media within the metering head.

Preferably, the fluid lines can comprise a mixing section for combining at least two media to form a mixture. For example, this makes it possible to automatically premix various reagents immediately before the reaction, prior to combining them with an analyte (sample) in a carrier substrate or a microfluidic cartridge. The metering head thus does not come into contact with the sample material and remains contamination-free. Any residual reagents can be removed by rinsing. At the same time, a recurring functionality is outsourced to the metering head, which simplifies the assembly of the microfluidic cartridge.

Preferably, at least two dispensing terminals are provided, wherein a distribution structure is provided in which a fluid line connected to one of the at least two media inlets branches into at least two line branches each connected to one media outlet per dispensing terminal. Of course, multiple of the fluid lines or all of the fluid lines connected to the at least two media inlets can also branch into at least two line branches, each connected to one media outlet per dispensing terminal, by means of such a distribution structure.

When this refers to a fluid line “connected” to a media inlet or a fluid line or line branch connected to a media outlet, this also includes indirectly connected fluid lines or line branches with interposed functional elements or other fluidic structures and fluid lines or line branches that can be temporarily disconnected, for example by means of a valve.

In an advantageous embodiment, the distribution structure comprises at least one single branching, at which the branching fluid line splits into two line branches.

Furthermore, the branching fluid line and/or the line branches in the region of the single branching each preferably have at least one deflecting element for a medium flowing in the fluid line. The at least one deflecting element is preferably formed either by a meander-shaped course of the branching fluid line or the line branches or by one or multiple barriers arranged transversely to a main flow direction in the branching fluid line or in the line branches and projecting into the flow.

At a single branch, a media flow splits into two partial flows. The single branch can favour a preferably symmetrical shape so that the volume flow of both partial flows is the same. This is important so that all outlet terminals can be controlled synchronously in terms of flow. To further improve the evenness of the flow distribution, the fluid flow is deflected directly upstream or downstream of the distribution by means of the deflecting element. This creates turbulence in the area of the single branch, which counteracts any preferential direction of the flow in either branch of the line.

By arranging n>1 successive single branches in the direction of flow in the fluid line connected to a media inlet, the fluid line can be branched into 2″≥m>n line branches each connected to a media outlet.

As an alternative to an arrangement of multiple single branches in series or elsewhere in addition thereto, the metering head according to a further aspect of the invention has at least three dispensing terminals and a distribution structure with multiple branching are provided, wherein in the multiple branching a fluid line connected to one of the at least two media inlets branches into at least three line branches each connected to a media outlet per dispensing terminal, wherein the multiple branching has a distribution chamber with a longitudinal direction, along which the distribution chamber tapers downstream in steps or continuously from a largest cross-section to a smallest cross-section, wherein the fluid line connected to the media inlet opens into the distribution chamber in the region of the largest cross-section and the at least three line branches, each connected to a media outlet per dispensing terminal, branch off from the distribution chamber successively in the longitudinal direction at different cross-sections.

Terms such as “downstream” or “in the direction of flow” always refer to the direction along which the media in the fluid lines flow from the media inlets to the media outlets.

The distribution chamber is preferably designed as a stepped bore. This can have advantages in terms of production technology. Alternatively, the distribution chamber can also be a wedge-shaped or stepped chamber with a rectangular cross-section.

Preferably, a valve is connected upstream of each of the at least two media inlets or, optionally, a valve is arranged in each fluid line directly connected to a media inlet.

This allows the flow of both media to be controlled separately. If the valve is connected upstream of at least two media inlets, it is preferably flange-mounted to the metering head. If the valve is arranged in a fluid line directly connected to a media inlet, it is located downstream of the media inlet but before a first branching or mixing section.

Advantageously, the metering head and in particular the dispensing terminals comprise means for retaining an inflow of fluids through the media outlets into the metering head.

Contamination of the metering head can thus be avoided. The means for retaining an inflow of fluids through the media outlets into the metering head are preferably arranged in the region of the media outlets in the one or multiple dispensing terminals. They are preferably formed by a filter, a membrane or a barrier.

Particularly preferably, a Teflon membrane (more precisely, a membrane made of polytetrafluoroethylene, PTFE) is arranged in the region of the media outlets at or in the one or multiple dispensing terminals. Such a Teflon membrane prevents liquids from penetrating the system, especially in the air dispensing terminals or gas dispensing terminals. If the Teflon diaphragm is wetted from the outside, it fluidically seals the media outlet by closing the pores due to the surface tension of the liquid and preventing any medium from penetrating the metering head from the outside. If the Teflon diaphragm is wetted from the outside, it fluidically seals the media outlet by closing the pores thanks to the surface tension of the liquid, preventing any medium from penetrating the metering head from the outside. In the worst-case scenario, if the membrane remains wet for a longer period of time, it can be replaced. Preferably, the means for retaining, i.e. in particular the filters, membranes or barriers, are connected to the one or multiple dispensing terminals by thermal welding, bonding (substance-to-substance) or pressing (form-fit and friction-fit).

The invention is further solved by a metering system with a metering head of the type described above, with at least one connecting element for fluidic connection of the metering head to a carrier substrate or a microfluidic cartridge and optionally with a connecting piece, wherein the dispensing terminals is configured to directly accommodate the connecting element, preferably in a liquid-tight manner, or to indirectly accommodate the connecting element via the connecting piece (adapter).

The connecting element is used for the fluidic connection of the metering head to a carrier substrate, such as a microtiter plate or a microfluidic cartridge, depending on how the metering head is currently being used. The connecting element is preferably selected from the group consisting of pipette tip, capillary, dispensing needle, cannula, Luer connector, channel orifice with sealing element, nozzle and microfluidic head adapter. A head adapter is a connecting element between one or preferably multiple connection terminals and one or preferably multiple inlets of a microfluidic cartridge. Accordingly, it is specially adapted for use together with a specific microfluidic cartridge. An elastomer seal or a moulded elastic sealing element, for example in the form of a sealing lip, or simply a conical or flat sealing surface can be considered as a sealing element for the channel orifice,

The dispensing terminals are suitable for accommodating such a connecting element, in particular in a liquid-tight manner, which can be replaced after use. After changing the connecting element, the metering head is immediately available for reuse. The dispensing terminals preferably have a sealing element for this purpose. The sealing element can be a sealing surface or a sealing lip or an elastomer seal which, when connected, rests against a complementary sealing element of the connecting element. The dispensing terminals can, for example, comprise a frustoconical attachment as a receptacle onto which a pipette tip with a complementary inner surface can be directly attached in a liquid-tight manner. Alternatively or additionally, the dispensing terminals can have a bore or a conical countersink as a receptacle into which, for example, a cannula with a complementary outer surface can be inserted in a liquid-tight manner. In particular, the dispensing terminals can comprise a plurality of different receptacles for receiving different connecting elements. When using a connection piece, complementary sealing elements are provided between the dispensing terminals and the connection piece on the one hand and between the connection piece and the connecting element on the other. As a rule, the cone of the sealing surfaces of the dispensing terminals or the connection piece on the one hand and the connecting element on the other hand is designed such that the connecting element is fixed in a friction-fitting manner on or in the respective receptacle of the dispensing terminals or the connection piece.

In addition to the sealing element, the dispensing terminals or the connection piece can also comprise a latching element which interacts with a complementary latching element on the connecting element such that the connecting element, when connected, is held on the metering head in an interlocking manner.

When using a connection piece, complementary fixing or locking elements are provided between the dispensing terminals and the connection piece. Locking elements are defined as elements suitable for automatic ejection as opposed to fixing elements. If the connection piece is to remain permanently on the metering head, fixing elements can be considered. If it is to be exchanged with the connecting element, locking elements can be considered. Locking elements can also be used as a direct connection between the dispensing terminals and the connecting element (i.e. without a connection piece).

Furthermore, the metering system can be characterised by a standardised mounting system in which the dispensing terminals as well as a plurality of connecting elements each have standardised complementary shapes, so that the metering head can be equipped with a plurality of connecting elements.

The connecting element optionally has an integrated functional element. The integrated functional element is preferably selected from the group of mixing structure, permanent magnet, filter element and fragmenting element. An integrated mixing structure can be used for “late mixing” of the two media output from the at least two fluidically separated media outlets immediately prior to input into the carrier substrate or microfluidic cartridge. An integrated permanent magnet can be used for filtering magnetic particles and an integrated filter element for filtering cells, nanoparticles, polymers, exosomes, liposomes, etc. in particular. With an integrated fragmentation element, RNA/DNA can be fragmented mechanically, with the help of ultrasound or by means of other strong shear forces. Such methods are known as “shotgun sequencing” and “French press”.

The functionalisation of the connecting element is not only, but also particularly, possible in the case of a head adapter. This head adapter can have as an integrated functional element, in particular one or multiple actively controllable elements, for manipulating and/or detecting the medium, a passive mixing structure, an activatable mixer, a heating device, a cooling device, a passive or controllable magnet, a means for retaining an inflow of fluids from the microfluidic cartridge into the metering head.

Just like the connecting element, the optional connection piece can also have a functional element integrated into a fluid channel, in particular an actively controllable element for manipulating and/or detecting the medium, a passive mixing structure, an activatable mixer, a heating device, a cooling device, a passive or controllable magnet, a temperature sensor, an electrode or a means for retaining an inflow of fluids from the microfluidic cartridge into the metering head.

Due to the means integrated in the connection piece for retaining an inflow of fluids from the microfluidic cartridge into the metering head, this means is assigned to the connection piece designed for single use and is disposed of with the connection piece after use. This further reduces the risk of contamination. Additionally or alternatively to the connection piece, however, the dispensing terminals and/or the connecting element can also have means for retaining an inflow of fluids through the media outlets into the metering head. This would reduce the probability of a fluid contaminated with the sample to be analysed, for example, entering at each stage from the connecting element via the connection piece to the metering head. Since both the connecting element and the connection piece are designed for single use, the only crucial factor is that the sample to be analysed must never be allowed to reach the metering head from the microfluidic cartridge, which is also designed for single use, whereas consumables could be premixed in the metering head or in the connecting element in a timely manner and then dosed out.

Additionally or alternatively to the dispensing terminals, the connecting element or, if present, the connection piece can also have means for retaining an inflow of fluids through the media outlets into the metering head. This would prevent a fluid contaminated with the sample to be analysed, for example, from entering the connecting element or connection piece. Since both the connecting element and, if applicable, the connection piece are designed for single use, the only crucial factor is that the sample to be analysed must never be allowed to reach the metering head and, if applicable, the connection piece from the microfluidic cartridge, which is also designed for single use, whereas consumables could be premixed promptly in the metering head or in the connecting element and then dosed out.

### BRIEF DESCRIPTION OF THE DRAWINGS

The invention is explained in more detail below with reference to the drawings. In the figures:

FIG. 1A front view of a first exemplary embodiment of a metering system;

FIG. 2 a perspective view of a second exemplary embodiment of a metering system;

FIG. 3 a perspective view of a third exemplary embodiment of a metering system;

FIG. 4 an enlarged view of a deflecting element in the region of a single branch;

FIG. 5 an enlarged view of an embodiment of a dispensing terminals in lateral section;

FIG. 6 an enlarged view of the dispensing terminals according to FIG. 5 as seen from below;

FIG. 7 an enlarged view of a connection piece compatible with the dispensing terminals shown in FIGS. 5 and 6;

FIG. 8 a perspective view of a fourth exemplary embodiment of a metering system;

FIG. 9 an enlarged view of a second connection piece;

FIG. 10 an enlarged view of a third connection piece;

FIG. 11 the connection piece according to FIG. 10 with connecting element;

FIG. 12 a fourth connection piece with connecting element;

FIG. 13 a fifth connection piece with connecting element and

FIG. 14 the fifth connection piece according to FIG. 13 with a connected microfluidic cartridge.

### DETAILED DESCRIPTION OF THE INVENTION

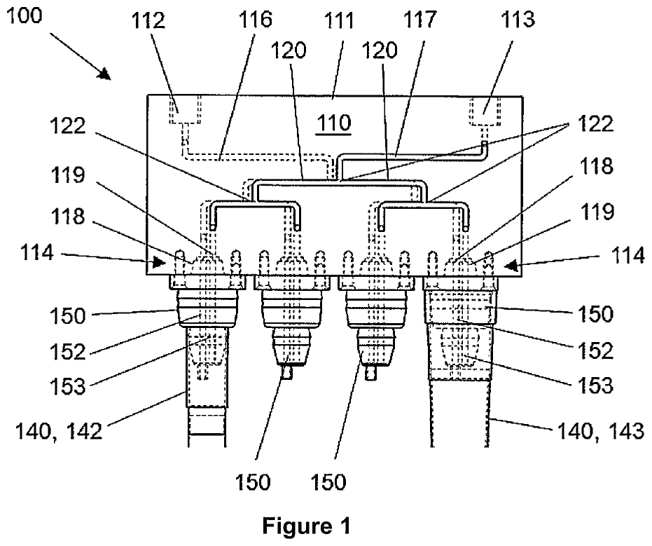

The metering system 100 according to FIG. 1 comprises a metering head 110. The metering head 110 has a substrate 111 in which fluidic structures are moulded. In this exemplary embodiment, the fluid structures in the metering head 110 comprise two media inlets 112, 113 for receiving two media, four dispensing terminals 114 for dispensing the media and fluid lines 116, 177 connecting the media inlets 112, 113 to the dispensing terminals 114. Each of the dispensing terminals 114 has two fluidically separate media outlets 118, 119. Both media inlets 112, 113 are each connected to a media outlet 118, 119 for each outlet terminal 114 by means of a fluidically isolated fluid line 116, 117. Isolated means that both fluid lines 116, 117 each form a direct line between the media inlets 112, 113 and the media outlets 118, 119 without the fluids coming into contact with each other. This is achieved by design in this exemplary embodiment in that the first fluid lines 116 associated with the first media inlet 112 extend in a first plane and the second fluid lines 117 associated with the second media inlet 113 extend in a second plane offset perpendicular to the drawing plane with respect to the first plane.

This embodiment of the metering head 110 does not include any further functional elements and serves solely to distribute two media to the media outlets 118, 119 of the four dispensing terminals 114. For example, the isolated fluid lines can be used exclusively for the separate dispensing of a transport medium (e.g. air) supplied via the first media inlet 112 and a reagent medium supplied via the second media inlet 113.

In order to distribute, a distribution structure is provided in which the fluid lines 116, 117 connected to media inlets 112, 113 each branch into four line branches 120 each connected to a media outlet 118. For this purpose, the distribution structure comprises three single branches 122 for each fluid line 116, 117, at which the branching fluid lines 116, 117 are each split into two line branches 120. The three single branches 122 are arranged such that in each fluid line 116, 117 two single branches 122 follow one another in the direction of flow, resulting in the m=2² line branches at the end.

The metering system 100 also comprises connecting elements 140. The connecting elements serve to fluidically connect the metering head 110 to a carrier substrate not shown, such as a microtiter plate or a microfluidic cartridge, depending on how the metering head is currently being used. For example, two pipette tips 142, 143 with different diameters or volumes are shown here as connecting elements. Depending on the application, the connecting element can also be a pipette tip, a capillary, a dispensing needle, a cannula, a Luer connector, a channel orifice with sealing element, a nozzle or a complex microfluidic head adapter with a plurality of identical and/or different connections.

The metering system 100 further comprises four identical connection pieces 150. Each of the connecting pieces 150 serves as an adapter between the dispensing terminals 114 of the metering head 110 and a connecting element 140 and can be ejected automatically or manually or, as in the case shown, can be fixed permanently, detachably or non-detachably, so as to resistant to damage, to the metering head 110 by means of screws or generally by means of fixing elements. Corresponding screw holes are provided in the metering head 110, associated with each dispensing terminals 114. In this case, it is intended that the connection piece remains permanently on the metering head and should not be replaced with the connecting element. The connecting pieces each have two insulated fluid channels 152, 153, which in the flanged state each communicate fluidically with one of the two media outlets 118, 119. The fluid lines 116, 117 in the metering head therefore continue fluidically isolated from each other in the two fluid channels 152, 153.

The connection pieces 150 have various stepped outer cross-sections to accommodate the different pipette formats, as shown in FIG. 1. Furthermore, they can also have one or multiple internal cross-sections for the liquid-tight insertion of cannulas, needles and the like. The connection pieces 150 can therefore be referred to as universal adapters. The dispensing terminals 114 is thus suitable for receiving a plurality of different connecting elements 140 in a liquid-tight manner by means of connection piece 150, which can be replaced after use. The connection piece 150 remains on the metering head. Complementary conical sealing surfaces serve as sealing elements between connection piece 150 and connecting element 140. As a rule, the cone of the sealing surfaces of the connection piece and the connecting element is designed such that the connecting element is fixed in a friction-fitting manner on or in the respective receptacle.

In addition to the sealing element, the connection piece 150 can also comprise a latching element which interacts with a complementary latching element on the connecting element in such that the connecting element, when connected, is held on the metering head in an interlocking manner.

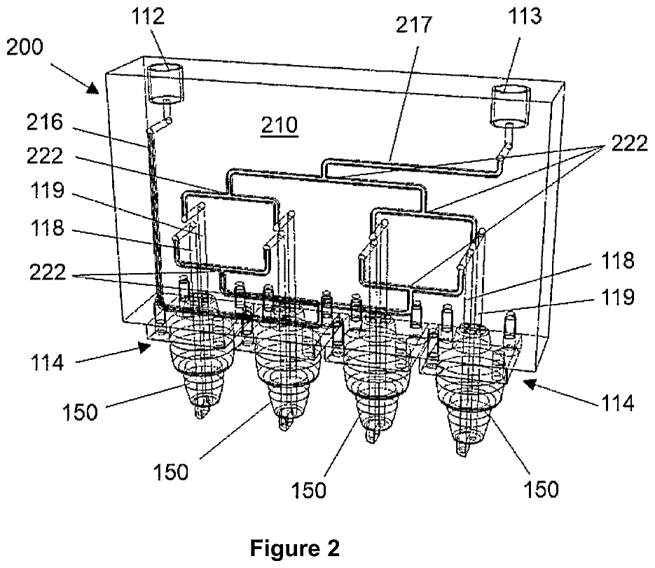

The metering system 200 according to FIG. 2 comprises predominantly identical elements and structures, which in this respect are also provided with the same reference numerals as the example according to FIG. 1. In this respect, reference is made to the above description. The main structural difference between this metering head 210 and that shown in FIG. 1 is that the single branches 222 and the fluid lines 216, 217 lie in the same plane intermittently between the media inlets 112, 113 and the dispensing terminals 114 and only jump back to different planes directly in front of the media outlets 118, 119. This can be advantageous when forming the channel structures which form the fluid line sections lying in a common plane close to the surface.

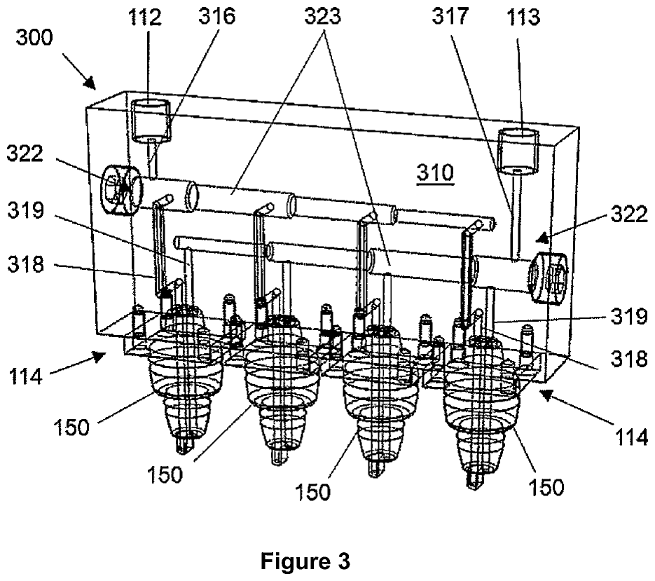

The metering system 300 according to FIG. 3 essentially differs from the two preceding examples in that a distribution structure with a quadruple branch 322 per fluid line 316, 317 is provided in the metering head 310 in lieu of the distribution structure with three single branches per fluid line. The quadruple branches 322 each have a distribution chamber 323 with a longitudinal direction along which the distribution chambers 323 taper downstream in steps from a largest cross-section to a smallest cross-section. The fluid lines 316, 317 connected to the media inlets 112, 113 open into the distribution chambers 323 in the region of the largest cross-section in each case. The four line branches, each connected to a media outlet 318, 319 per dispensing terminals 114, branch off from the distribution chambers 323 successively in the longitudinal direction at different cross-sections. The distribution chambers 323 are each designed as a stepped bore. This way, in each of the quadruple branches 322, the fluid lines 316, 317 connected to the respective media inlet are branched into the four line branches each connected to a media outlet 318, 319 per dispensing terminals 114.

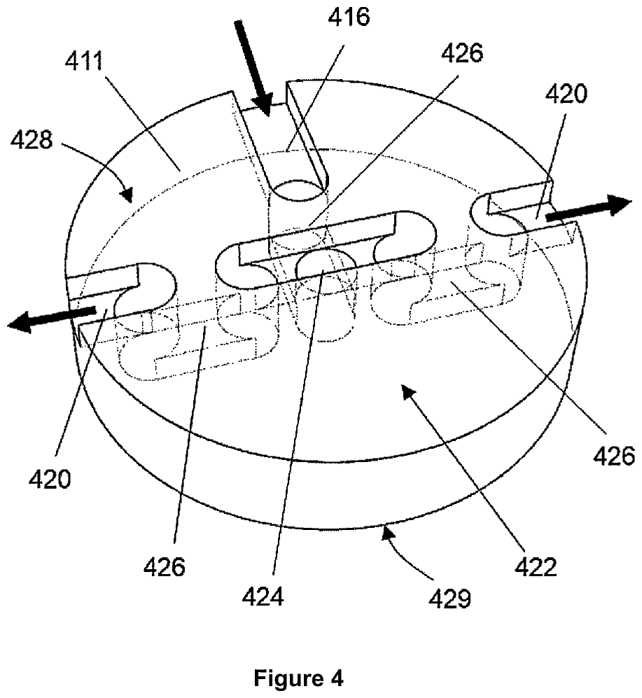

The distribution structure with single branching shown in FIGS. 1 and 2 is explained in more detail in a preferred variant with reference to FIG. 4. At the single branch 422, the branching fluid lines 416 split into two line branches 420. The direction of flow of the medium or media is indicated by arrows. The branching fluid lines 416 and the line branches 420 each have a deflecting element 426 for a medium flowing in the fluid line in the region of the single branch, that is, adjacent to the junction 424 at which the branching fluid lines 416 and the two line branches 420 meet. In this example, the branching fluid line 416 and the two line branches 420 extend as channels predominantly in a topside 428 of the substrate 411. The deflecting element 426 are formed by the branching fluid lines 416 and the two line branches 420 adjacent to the junction 424 each jumping once through the substrate 411 to the opposite underside 429 of the substrate 411, in this example perpendicular to the plane defined by the topside or underside, extending there a short distance in the form of channels and then jumping back through the substrate 411 to the topside 428, where they continue their course. The deflecting elements 426 are thus formed by a meander-shaped course of the branching fluid lines 416 and the line branches 420. Of course, there are numerous variations of the meander-shaped course shown here. For example, the channels can be deflected multiple times parallel to the topside 428. The crucial point is that the deflecting elements 426 create turbulence in the area of the single branch 422, which counteracts any preferential direction of the media flow in the region of the single branch 422 into the or other line branch.

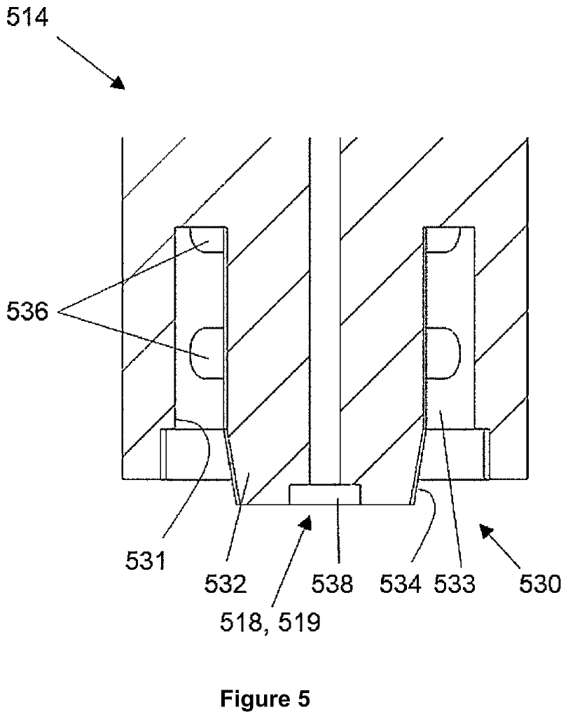

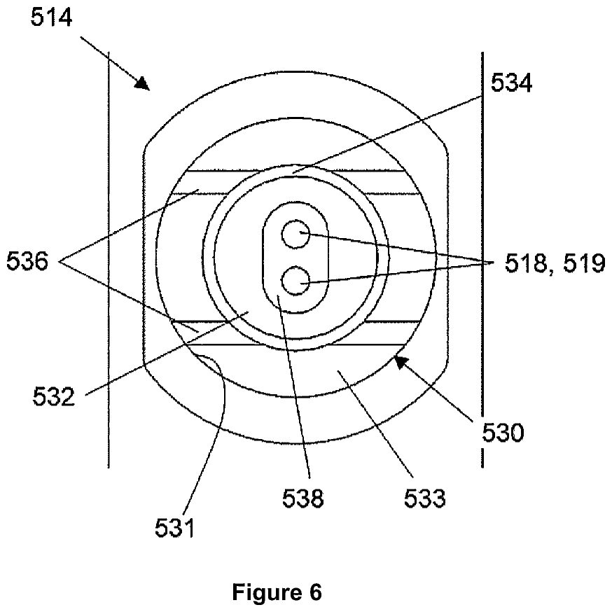

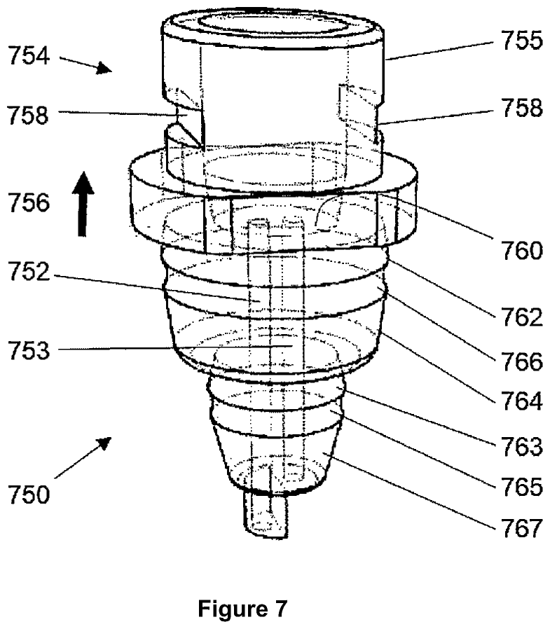

FIGS. 5 and 6 show an embodiment of a dispensing terminals 514 in lateral section or from below. This is a different embodiment to that shown in FIGS. 1 and 2. The dispensing terminals 514 is configured to indirectly accommodate, in a liquid-tight manner, a connection piece 750 as shown in FIG. 7, which serves as an adapter between the dispensing terminals 514 and a connecting element (not shown here).

In this example, the dispensing terminals 514 and the connection piece 750 are designed to be ejected automatically or manually. In this case, it is provided that the connection piece 750 is replaced together with the connecting element after use.

The dispensing terminals 514 has a connecting structure 530 for receiving and a locking element (not shown) for releasably fixing the connection piece 750. The connecting structure 530 is formed by a cylindrical bore 531 with a coaxial centring pin 532, between which an annular gap 533 is formed. The connection piece 750 has a complementary connection structure 754 with an attachment in the form of a hollow cylinder 755, which can be inserted in an interlocking manner into the annular gap 533 in an insertion direction 756. The centring pin 532 has a centring cone 534 to facilitate insertion of the connection piece 750.

The locking element is arranged in the dispensing terminals 514 so as to be movable in a guide direction transverse to the insertion direction between a locking position and a release position. Guide channels 536 serve as guides. In the locked position, the locking element engages in corresponding guide grooves 758 in the outer wall of the hollow cylinder 753, whereby the locking element locks the connection piece 750 when inserted.

The dispensing terminals 514 have two fluidically separated media outlets 518, 519, which are arranged successively perpendicular to the plane of representation of FIG. 5. The connection piece 750 has two corresponding fluid channels 752, 753, wherein each fluid channel 752, 753 of the connection piece 750 communicates fluidically with one of the media outlets 518, 519 of the dispensing terminals 514 when inserted.

Furthermore, the dispensing terminals 514 has a recess 538 on its underside for receiving a sealing element in the form of an oval elastomer disc (not shown) with two openings for the media outlets 518, 519. The sealing element forms an axial seal which interacts with a sealing surface 760 on the base of the hollow cylinder 755.

The connection piece 750 in turn serves as an adapter between the dispensing terminals 514 and a connecting element. It has various stepped outer cross-sections 762, 763 to accommodate different connecting elements. The connection piece 750 can therefore be described as a universal adapter. Complementary conical sealing surfaces 764, 765 serve as a sealing element between the connection piece 750 and the connecting element. The cone of the sealing surfaces of the connection piece 750 and the connecting element is designed such that the connecting element is fixed in a friction-fitting manner on or in the respective receptacle. In addition, each outer cross-section is also assigned a latching element in the form of an annular groove 766, 767, which interacts with a complementary latching element in the form of an internal annular bead on the connecting element such that the connecting element, when connected, is held on the connection piece 750 in an interlocking manner.

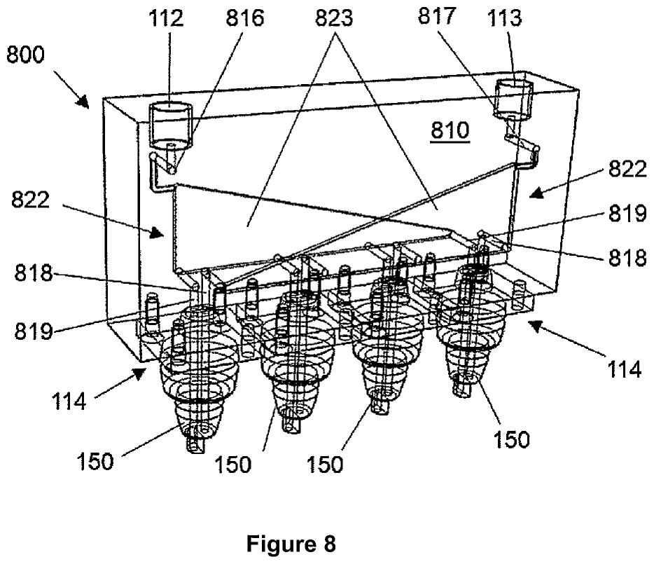

FIG. 8 shows a further exemplary embodiment of a metering system 800 with a distribution structure each comprising a quadruple branch 822 of the fluid lines 816, 817. The metering system 800 according to FIG. 8 differs essentially from the example according to FIG. 3 in that the quadruple branches 822 each comprise a distribution chamber 823 with a rectangular cross-section, which tapers continuously in the longitudinal direction downstream from a largest cross-section to a smallest cross-section. The fluid lines 816, 817 connected to the media inlets 112, 113 open into the distribution chambers 823 in the region of the largest cross-section in each case. In this case, the four line branches, each connected to a media outlet 818, 819 per dispensing terminals 114, also branch off from the distribution chambers 823 successively in the longitudinal direction at different cross-sections. In this way, in each of the quadruple branches 822, the fluid lines 816, 817 connected to the respective media inlet are branched into the four line branches each connected to a media outlet 818, 819 per dispensing terminals 114.

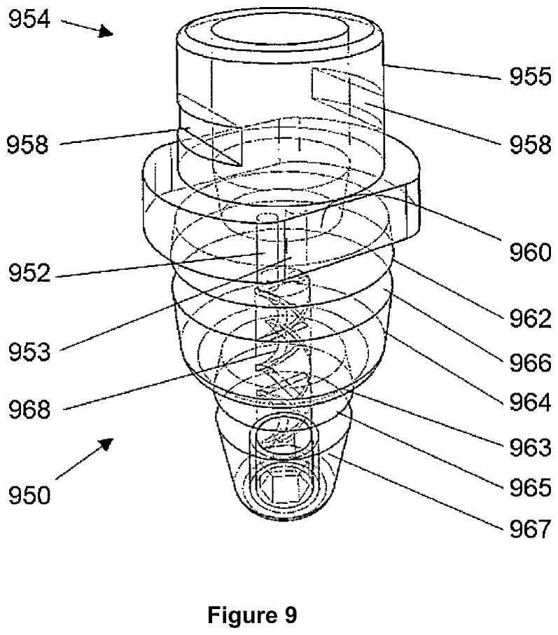

The connection piece 950 shown in FIG. 9 has two initially fluidically separated fluid channels 952, 953, wherein in the plugged-in state each fluid channel 952, 953 of the connection piece 950 communicates fluidically with one of the media outlets 118, 119 of the dispensing terminals 114. With regard to the connection structure 954, the hollow cylinder 955, the guide grooves 958, the sealing surface 960, the stepped outer cross-sections 962, 963, the conical sealing surfaces 964, 965 and the annular grooves 966, 967, the connection piece 950 is designed identically to the connection piece 750 shown in FIG. 7. It differs in that it has a mixing structure 968 as an integrated functional element in its lower region downstream of the fluid channels 952, 953. In this example, the mixing structure is designed as a so-called Kenics mixer.

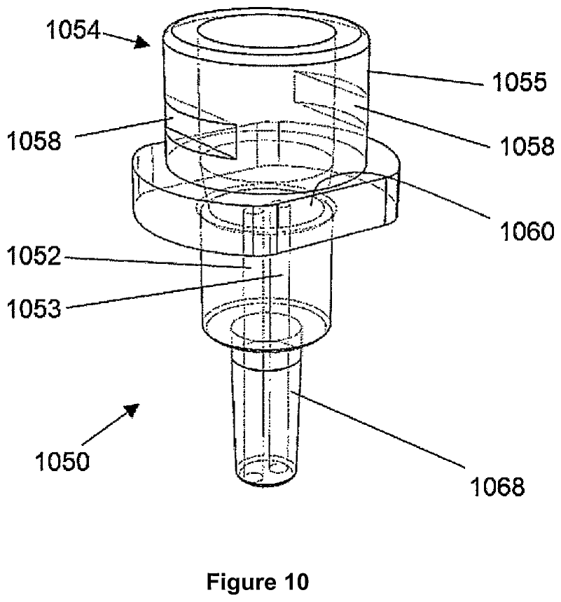

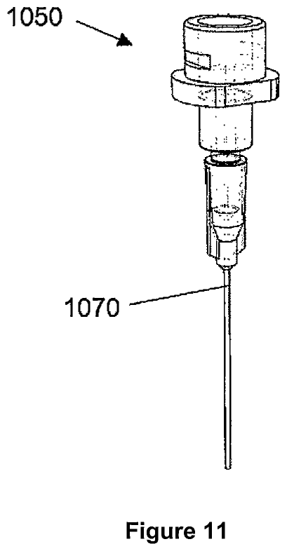

The connection piece 1050 shown in FIG. 10 again has two continuous fluidically separated fluid channels 1052, 1053, which in the plugged-in state communicate fluidically with one of the media outlets 118, 119 of the dispensing terminals 114. The connection structure 1054 of the hollow cylinder 1055 and that of the guide grooves 1058, as well as the sealing surface 1060, is identical to those of the two previous examples according to FIGS. 7 and 9. The connection piece 1050 differs from these with regard to the receptacle 1068, which is designed here as a so-called Luer cone and is suitable for receiving, for example, a dispensing needle 1070 as a connecting element, as shown in FIG. 11.

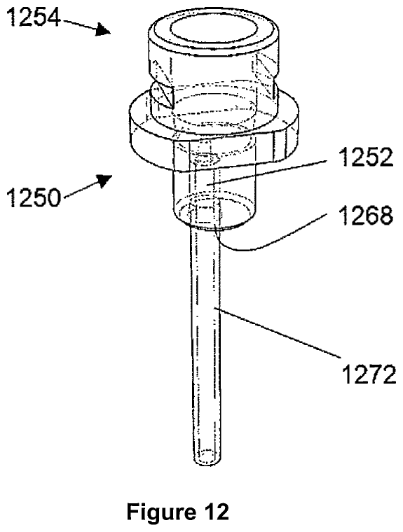

The connection piece 1250 shown in FIG. 12 again has an identical connection structure 1254 as all the examples described above. In contrast to these, it has only one fluid channel 1252 which, when inserted, communicates fluidically with one of the media outlets 118, 119 of the dispensing terminals 114. The connection piece 1250 further differs again with respect to the receptacle 1268, which is configured here to receive capillaries 1272 as a connecting element.

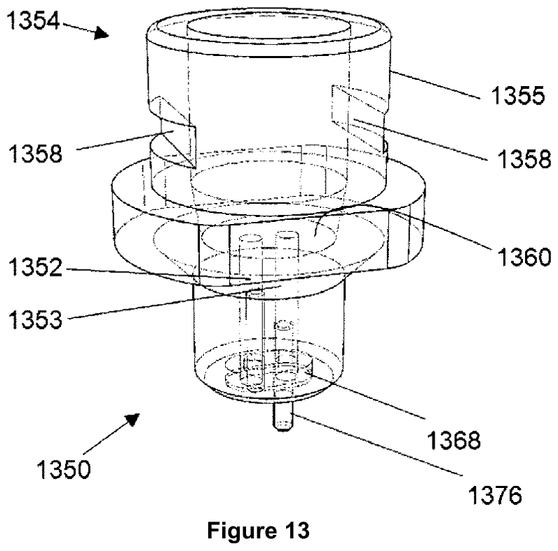

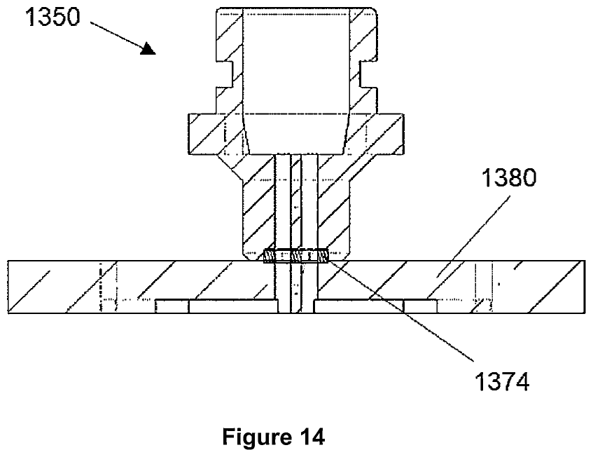

The connection piece 1350 shown in FIG. 13 again has an identical connection structure 1354 as all the examples described above. It also again has two fluid channels 1352, 1353 which are fluidically separated throughout and which, when inserted, communicate fluidically with one of the media outlets 118, 119 of the dispensing terminals 114. In contrast to the other examples, it differs again with regard to the receptacle 1368, which is designed here to receive an elastomer seal 1374 as a sealing element and a centring element in the form of a hollow cylindrical centring pin 1376. As can be seen in FIG. 14, the connection piece 1350 with the elastomer seal 1374 is placed in a liquid-tight manner on the surface of a microfluidic cartridge 1380, wherein the pins 1376 ensure precise alignment of the orifices of the fluid channels 1352, 1353 with the fluid inlets in the cartridge.

The metering system according to the invention can be used as a single or multi-channel pipette. Its use is not limited to liquid transfer with pipette tips, but the metering system can also be equipped with other auxiliary means such as capillaries, dispensing needles, cannulas, Luer connectors, channel orifices with sealing elements, nozzles or a complex microfluidic head adapter. The metering system can be operated manually or automatically, for example in line, room gantry or robot or cobot systems. The metering head is controlled via syringe pumps filled with air or liquid, for example. This makes it possible to use the microfluidic metering system as a pipette on the one hand and to convey fluids via the metering system on the other. It is also possible to use the microfluidic metering system as an actuator for microfluidic cartridges by applying individual pressures to the various dispensing terminals. The present invention thus enables sample enrichment and processing with sample analysis to be realised using the microfluidic metering system in combination with a microfluidic cartridge (lab-on-a-chip).

Various specific application examples are described below.

### Single Pipette Holder:

The metering head can be used as a single pipette holder with multiple microfluidic passages for different media (gases, e.g. air, and/or liquids, e.g. wash buffer). The advantages of this are:
Multiple use of the pipette tip and therefore fewer reaction vessels;
Due to the lower number of transfers of the sample to other reaction vessels, fewer losses of beads and thus of cells, CTCs (circulating tumour cells) or CTC clusters are to be expected;
Possibility of detaching the beads from the pipette without shear forces by drawing in air and the resulting bubble formation, which means that less loss of vitality can be achieved. This also enables the enrichment of complex cell clusters, e.g. CTC clusters

Possible application scenarios are:
Cell cultures of stem cells. The advantages here are fewer pipette tips and contamination-free media addition (e.g. via Luer connectors) through additional microfluidic passages, which can be connected to medium reservoirs.
Enrichment of CTC clusters. The enrichment of CTC clusters is highly interesting for research, and in future certainly also for diagnostics. It is assumed that the analysis of CTC clusters can provide further information about the tumour disease and will be relevant not only for diagnostics but also for therapy. It is therefore necessary to ensure that the cluster structures are not destroyed during enrichment from a patient blood sample. Previous automated methods for enrichment, such as those used in the current CTCelect system, are based on draining the medium and resuspending the beads and the CTCs and CTC clusters bound to them by pipetting them up and down multiple times. The medium and the cells are repeatedly pressed through the narrow opening of the pipette tip. This process results in high shear forces, which can impair the vitality of the cells bound to the beads. In the case of CTC clusters, it can be assumed that the clusters are destroyed by flowing through the pipette tip up to 100 times.
The single pipette holder with microfluidic channels used here is suitable for normal pipetting on the one hand, but also for feeding wash buffers through an additional channel.
In this scenario, the invention enables the beads to be held magnetically in the pipette tip after the sample including the magnetic beads has been added and a subsequent incubation. After draining the blood sample, wash buffer is now added to the pipette tip through the additional opening of the pipette holder and the beads are released from the pipette by air bubbles flowing past the inner wall of the pipette by subsequently drawing air into the pipette tip. This is only possible because the pipette holder is not a reciprocating pipette. This makes it possible to take up air for a longer period of time, which is necessary for detaching the beads. After detachment, which is also the washing step, the beads (with CTC clusters) are magnetically attracted to the pipette again and the wash buffer is drained. This has the advantage already mentioned that the CTC clusters are not exposed to shear forces when being drained and aspirated through the narrow opening of the pipette tip. In addition, the wash buffers are dispensed into a sample tube, which also reduces the consumption of reaction vessels. A particularly relevant advantage is the prevention of bead loss in the reaction vessels, as the beads are not drained into the reaction vessels. This results in a reduced loss of CTCs or CTC clusters.
The single pipette holder makes it possible to connect the reservoir with wash buffer directly without a tube, e.g. in the form of a cartridge, and can therefore either be replaced more cheaply or cleaned more easily if necessary, thus preventing contamination of the wash buffer with microorganisms.

### Multiple Pipette Holder:

The metering head can be used as a multiple pipette holder in conjunction with a microfluidic channel system. The fluidic division and functionalisation of the channels is highly variable. The advantages of this are:
Variable pipette holder;
No need to change the pipettes;
By avoiding a reciprocating pipette, no second robot arm and no complicated control or mechanical adjustment of the pipette is required for operation;
The control unit is more robust than a hose control unit, for example, which also makes it easier to install.

Possible application scenarios are:
General pipetting tasks, media distribution
Parallel analyses: Connection piece with measuring device
Parallel enrichment of CTCs. The advantage here is simple adaptation to existing demonstrators.
Immunoprecipitation and automated quantification of Aß peptides from blood plasma of Alzheimer's patients.
Immunoprecipitation and a subsequent ELISA (enzyme-linked immunosorbent assay) are necessary for the detection of Aß peptides from patient plasma.

Immunoprecipitation is a time-consuming process, which is partly due to the plurality of washing steps required. The same applies to carrying out an ELISA. This procedure is carried out manually in most laboratories and therefore ties up labour. Fully automated processes are usually carried out on a large scale using the King Fisher system, which allows up to 96 samples (including controls) to be precipitated. However, this plurality of samples is only necessary for scientific investigations; in everyday clinical practice, the system is out of proportion, as a smaller number (e.g. no more than 8 patients) per day can be assumed in a clinic. In addition, a plurality of special consumables (plates, adapters for magnets) are required. In addition to the intensive preparation for the King Fisher system, which involves pipetting at least 6 plates of 96 wells, the immunoprecipitation is followed by analysis by ELISA, which is also very time-consuming due to intensive manual pipetting. In addition, the samples must be transferred manually to a pipetting robot.

Tests with the invention show that immunomagnetic enrichment can be carried out in pipette tips. For rapid analysis of patient samples, it is also necessary to process samples in parallel. This is made possible by using the metering system according to the invention as a multiple pipette holder. With the aid of adapted demonstrators, immunoprecipitation of multiple samples can also be carried out simultaneously.

Compared to the King Fisher system, the multiple pipette holder can hold volumes of over 2 mL per sample, leading to improved detection as more protein can be enriched. After mixing the sample with magnetic beads and a plurality of washing steps, the Aß peptides are magnetically enriched in the pipette tips. The advantage of the multiple pipette holder in the case of Aß peptide detection is the possibility of subsequent enrichment of an ELISA on a microfluidic cartridge automatically and without manual transfer. In the process, the multichannel pipette serves as a sampler and at the same time as an actuator for the cartridge. This means that the sample is transported fluidically in the cartridge. This is possible due to the metering system according to the invention, which differs from the known reciprocating pipettes in particular due to the lack of volume limitation. In addition, a simplified detection system can be used in the microfluidic cartridge, which does not need to have its own pump systems. Pumping is facilitated by the pump connected to the multi-channel pipette holder, as this enables “over-pipetting”. The distribution of air through the microfluidic channels has the advantage over individual tube connections that at most one tube connection needs to be laid in the systems. In addition, it is also conceivable to place pump systems, for example in the form of micropumps, directly on or integrated in the metering head. The option of using hose distributors also has disadvantages compared to the microfluidic metering system, as the hose connections are less robust and more complex to handle.

By modifying the metering system, as in the case of the above-mentioned “single pipette holder”, the system can be equipped with further advantages over hose connections.

Wash buffers can be transferred directly into the cartridge, even with multiple pipette holders, without having to “uncouple” pipettes from the cartridge. For the ELISA after immunoprecipitation, this means that the washing steps can follow directly after the addition of the sample and an incubation time. The “microfluidic collection system” thus enables automated immunoprecipitation and subsequent ELISA on the microfluidic cartridge.

The advantage of the metering system according to the invention is the simplicity of the underlying design through the use of high-precision manufactured components by conventional or mass production processes, similar to the known lab-on-a-chip. The invention also enables flexibility, i.e. adaptability to one or multiple applications and the combination of different liquid transfer systems (e.g. pipette tip sizes) with one metering head. This makes it possible, particularly in automated systems, for pipette tips to be changed quickly, for example.

Using the metering system for actuation simplifies the control of complex fluidic structures on a microfluidic cartridge and replaces pumps and valves as well as complex additional external control by an operator device. In addition to the classic pipette tips for transferring reagents or for actuating e.g. microfluidic cartridges, cannulas or dosing needles etc. can also be used. It is also possible to attach the dispensing terminals directly to the cartridge. Only a sealing element is then used as the connecting element. This creates a direct connection between the dispensing terminals of the metering head and the cartridge via a conical or flat sealing surface.

In summary, the main advantages are the low weight and small size. In addition, the variable microfluidic metering system offers applications for liquid transfer, pumping with negative and positive pressure, direct connection of the metering head to the microfluidic cartridge (without pipettes or other connectors), the possibility of simplifying the microfluidic cartridge and the processes to be transferred to a microfluidic structure, and greater flexibility in the sequence of reagent addition, the transfer of different volumes, even at different times, without removing the pipette from the cartridge, safe recirculation of the volumes in pipette tips of the dosing system, recurring removal and addition of reagents from the connected microfluidic receptacle system (titre plate, cartridge). It is also possible to discard and drain them into a collection tray or container.

### LIST OF REFERENCE NUMBERS

100 Metering system
110 Metering head
111 Substrate
112 Media inlet
113 Media inlet
114 Dispensing terminal
116 Fluid line
117 Fluid line
118 Media outlet
119 Media outlet
120 Line branch
122 Single branch
140 Connecting element
142 Pipette tip
143 Pipette tip
150 Connection piece
152 Fluid channel
153 Fluid channel
200 Metering system
210 Metering head
216 Fluid line
217 Fluid line
222 Single branch
300 Metering system
310 Metering head
316 Fluid line
317 Fluid line
318 Media outlet
319 Media outlet
322 Quadruple branch
323 Distribution chamber
411 Substrate
416 Fluid line
420 Line branch
422 Single branch
424 Junction
426 Deflecting element
428 Topside
429 Underside
514 Dispensing terminals
518 Media outlet
519 Media outlet
530 Connection structure
531 Cylindrical bore
532 Centring pin
533 Annular gap
534 Centring cone
536 Guide channel
538 Recess
750 Connection piece
752 Fluid channel
753 Fluid channel
754 Connection structure
755 Hollow cylinder
756 Insertion direction
758 Guide groove
760 Sealing surface
762 Outer cross-sections
763 Outer cross-sections
764 Sealing surface
765 Sealing surface
766 Annular groove
767 Annular groove
800 Metering system
810 Metering head
816 Fluid line
817 Fluid line
818 Media outlet
819 Media outlet
822 Quadruple branch
823 Distribution chamber
950 Connection piece
952 Fluid channel
953 Fluid channel
954 Connection structure
955 Hollow cylinder
958 Guide groove
960 Sealing surface
962 Outer cross-sections
963 Outer cross-sections
964 Sealing surface
965 Sealing surface
966 Annual groove
967 Annual groove
968 Mixed structure
1050 Connection piece
1052 Fluid channel
1053 Fluid channel
1054 Connection structure
1055 Hollow cylinder
1058 Guide groove
1060 Sealing surface
1068 Receptacle, Luer cone
1070 Dispensing needle
1250 Connection piece
1252 Fluid channel
1254 Connection structure
1268 Receptacle
1272 Capillary
1350 Connection piece
1352 Fluid channel
1353 Fluid channel
1354 Connection structure
1355 Hollow cylinder
1358 Guide groove
1360 Sealing surface
1368 Receptacle
1374 Sealing element, elastomer seal
1376 Centring element, centring pin
1380 Microfluidic cartridge

What is claimed is:

1. A metering head for receiving and metering at least two media, having:
at least two media inlets,
one or multiple dispensing terminals, and
fluid lines, connecting the media inlets to the one or multiple dispensing terminals.
wherein the one or multiple dispensing terminals each have at least two fluidically separated media outlets.

2. The metering head according to claim 1, wherein the fluid lines comprise a mixing section for combining at least two media to form a mixture.

3. The metering head according to claim 1, wherein at least two dispensing terminals are provided, wherein a distribution structure is provided in which a fluid line connected to one of the at least two media inlets branches into at least two line branches each connected to one media outlet per dispensing terminal.

4. The metering head according to claim 3, wherein the distribution structure comprises a single branch at which the branching fluid lines split into two line branches.

5. The metering head according to claim 4, wherein the branching fluid lines and/or the line branches in the region of the single branch each have at least one deflecting element for a medium flowing in the fluid lines.

6. The metering head according to claim 5, wherein the at least one deflecting element is formed by a meander-shaped course of the branching fluid lines and/or the line branches.

7. The metering head according to claim 5, wherein the at least one deflecting element is formed by one or multiple barriers arranged transversely to a main flow direction in the branching fluid lines and/or in the line branches.

8. The metering head according to claim 1, wherein at least three dispensing terminals and a distribution structure with multiple branching are provided, wherein in the multiple branching a fluid line connected to one of the at least two media inlets branches into at least three line branches each connected to a media outlet per dispensing terminal, wherein the multiple branching has a distribution chamber with a longitudinal direction, along which the distribution chamber tapers downstream in steps or continuously from a largest cross-section to a smallest cross-section, wherein the fluid line connected to the media inlet opens into the distribution chamber in the region of the largest cross-section and the at least three line branches, each connected to a media outlet per dispensing terminal, branch off from the distribution chamber successively in the longitudinal direction at different cross-sections.

9. The metering head according to claim 8, wherein the distribution chamber is designed as a stepped bore.

10. The metering head according to claim 1, wherein a valve is connected upstream of each of the at least two media inlets, or that a valve is arranged in each fluid line directly connected to a media inlet.

11. The metering head according to claim 1, wherein the metering head, in particular the dispensing terminal, has means for retaining an inflow of fluids through the media outlets into the metering head.

12. A metering system having the metering head according to claim 1, with at least one connecting element for fluidically connecting the metering head to a carrier substrate or to a microfluidic cartridge, and optionally a connection piece,
wherein the dispensing terminal is designed to receive the connecting element directly or to receive the connecting element indirectly via the connection piece.

13. The metering system according to claim 12, wherein the connecting element is selected from the group consisting of pipette tip, capillary, dispensing needle, cannula, Luer connector, channel orifice with sealing element, nozzle and microfluidic head adapter.

14. The metering system according to claim 12, wherein the connecting element has an integrated functional element selected from the group consisting of a mixed structure, permanent magnet, filter element or fragmenting element.

15. The metering system according to claim 12, wherein the connecting element or the connection piece has means for retaining an inflow of fluids through the media outlets into the metering head.

16. The metering head according to claim 2, wherein at least two dispensing terminals are provided, wherein a distribution structure is provided in which a fluid line connected to one of the at least two media inlets branches into at least two line branches each connected to one media outlet per dispensing terminal, wherein the distribution structure comprises a single branch at which the branching fluid lines split into two line branches, and wherein the branching fluid lines and/or the line branches in the region of the single branch each have at least one deflecting element for a medium flowing in the fluid lines.

17. The metering head according to claim 16, wherein the at least one deflecting element is formed by a meander-shaped course of the branching fluid lines and/or the line branches.

18. The metering head according to claim 16, wherein the at least one deflecting element is formed by one or multiple barriers arranged transversely to a main flow direction in the branching fluid lines and/or in the line branches.

19. The metering head according to claim 16, wherein at least three dispensing terminals and a distribution structure with multiple branching are provided, wherein in the multiple branching a fluid line connected to one of the at least two media inlets branches into at least three line branches each connected to a media outlet per dispensing terminal, wherein the multiple branching has a distribution chamber with a longitudinal direction, along which the distribution chamber tapers downstream in steps or continuously from a largest cross-section to a smallest cross-section, wherein the fluid line connected to the media inlet opens into the distribution chamber in the region of the largest cross-section and the at least three line branches, each connected to a media outlet per dispensing terminal, branch off from the distribution chamber successively in the longitudinal direction at different cross-sections, wherein the distribution chamber is designed as a stepped bore, wherein a valve is connected upstream of each of the at least two media inlets, or that a valve is arranged in each fluid line directly connected to a media inlet, and wherein the metering head, in particular the dispensing terminal, has means for retaining an inflow of fluids through the media outlets into the metering head.

20. The metering system according to claim 13, wherein the connecting element has an integrated functional element selected from the group consisting of a mixed structure, permanent magnet, filter element or fragmenting element, and wherein the connecting element or the connection piece has means for retaining an inflow of fluids through the media outlets into the metering head.
